(19) United States
(12) Patent Application Publication
(10) Pub. No.: US 2007/0179926 A1
(43) Pub. Date: Aug. 2, 2007

(54) Data backup and restoration methods

(75) Inventor: Ming-Tsung Chiang, Taipei County (TW)

Correspondence Address: BIRCH STEWART KOLASCH & BIRCH, PO BOX 747, FALLS CHURCH, VA, 22040-0747, US

(73) Assignees: GIGA-BYTE COMMUNICATIONS INC.; GIGA-BYTE TECHNOLOGY CO., LTD.

(21) Appl. No.: 11/340,575

(22) Filed: Jan. 27, 2006

(51) Int. Cl. G06F 17/30

(52) U.S. Cl. 707/1

(57) ABSTRACT

A data backup method is implemented in a mobile phone. Backup occasion options respectively corresponding to different situations of the mobile phone are displayed. An option corresponding to a situation is selected from backup occasion options. When satisfying the situation corresponding to the selected option, the mobile phone automatically generates a backup by copying data therein to a portable storage device connected thereto.

### BACKGROUND OF THE INVENTION

1. Field of the Invention

The present invention relates to computer techniques, and more particularly to data backup and restoration method.

2. Description of the Related Art

As they become increasingly popular, mobile phones are provided with an increasing number of functions in addition to communication, such as maintenance of communication logs, messages, schedules, notes, video and audio data playback. A mobile phone storing important data, however, may crash and make the data therein inaccessible.

Some mobile phones can synchronize data with a personal computer comprising with a synchronization application. Data synchronization cannot take place without a computer and the synchronization application.

In some corporations, a common mobile phone may be shared, and settings of the common mobile phone may be changed by users or based on environmental factors. It is troublesome when manually modifying settings of the common mobile phone becomes a routine.

### BRIEF SUMMARY OF THE INVENTION

An exemplary embodiment of a data backup method is implemented in a mobile phone. Options, referred to as backup occasion options, respectively corresponding to different situations of the mobile phone are displayed. An option corresponding to a situation is selected from backup occasion options. When satisfying the situation corresponding to the selected option, the mobile phone automatically generates a backup by copying data therein to a portable storage device connected thereto.

An exemplary embodiment of a data restoration method is implemented in a mobile phone. It is automatically determined whether the portable storage device comprises backup data of the mobile phone upon a connection to a portable storage device. If so, restoration options comprising a replace action are automatically displayed. When the replace action is selected, data in the mobile phone is cleared. The backup data is restored to the mobile phone.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of the configuration of a mobile phone; and

FIG. 2 is a flowchart showing an exemplary embodiment of a data backup method;

FIG. 3 is a flowchart showing an exemplary embodiment of a data restoration method;

FIG. 4 is a schematic view showing data restoration action options;

FIG. 5 is a flowchart showing an exemplary embodiment of a data restoration method; and

FIG. 6 is a schematic view showing operation options.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

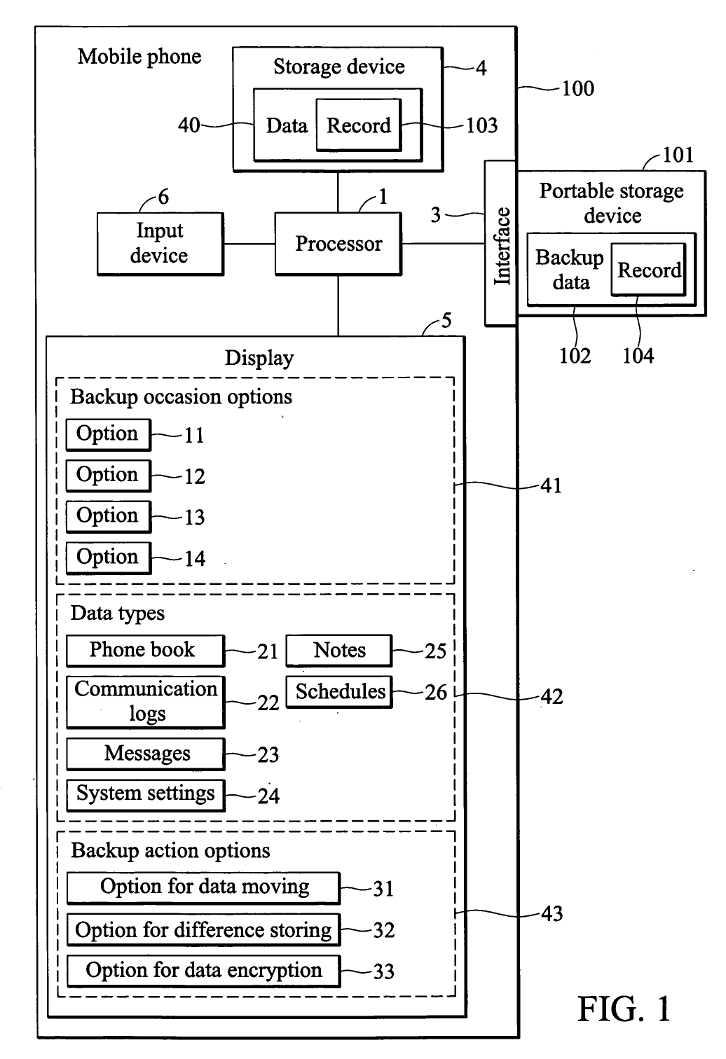

In mobile phone 100 of FIG. 1, processor 1 is coupled to interface 3, storage device 4, display 5, and input device 6. Interface 3 is utilized to connect portable storage device 101.

For example, portable storage device 101 comprises but is not limited to the following examples: a compact flash (CF) card, a SmartMedia (SM) card, a memory stick, a secure digital (SD) card, a xD-picture card, or an IBM Microdrive™. Storage device 4 may comprise a hard disk drive, a flash memory, or other storage medium. Display 5 may comprise a liquid crystal display (LCD), an organic light emitting diode (OLED) display, or a display of another type. Input device 6 may comprise a keyboard, a touch panel, a touch screen, or an input device of another type. Storage device 4 stores data 40.

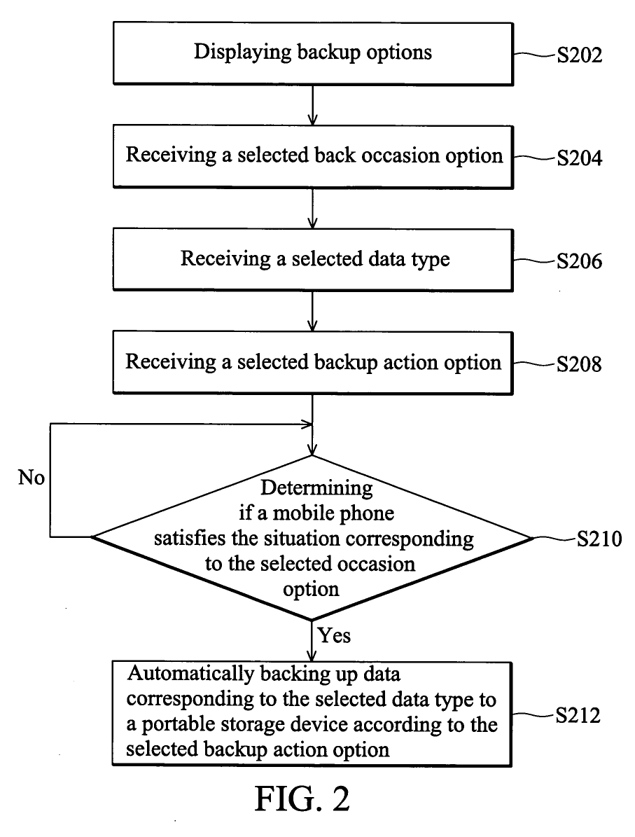

With reference to FIG. 2, mobile phone 100 implements a data backup method.

When interface 3 has been connected to portable storage device 101, processor 1 displays a plurality of backup options on display 5 (step S202), comprising backup occasion options 41, data types 42, and backup action options 43, as shown in FIG. 1.

Backup occasion options 41 comprise options 11-14 respectively corresponding to different situations for generating a backup. For example, option 11 indicates a time for periodic backup generation. Note that a backup period may be measured in any time unit, such as days, weeks, or months, and may be predetermined in advance or assigned utilizing input device 6. Option 12 indicates that mobile phone 100 is to generate a backup when receiving or transmitting a message. Option 13 indicates that mobile phone 100 is to automatically boot to generate a backup when having been shutdown for a predetermined period stored in mobile phone 100 in advance. The predetermined period can be assigned utilizing input device 6. Option 14 indicates that mobile phone 100 is to generate a backup after booting or before shutdown. Options 11-14 can be implemented by input fields, radio buttons, checkboxes, graphical user interface (GUI), or the combination thereof.

Data types 42 correspond to types of data 40, dedicated to be processed by different applications in mobile phones 100. For example, data types 42 comprise phone book 21, communication logs 22, messages 23, system settings 24, notes 25, and schedules 26. Phone book 21 may comprise user names, telephone numbers, and email addresses. Communication logs 22 comprise answered, unanswered, and called phone numbers and username thereof. Messages 23 may comprises short messaging services (SMS), enhanced messaging services (EMS), and multimedia messaging services (MMS) messages.

System settings 24 may comprises ring tones, voice volume, languages, time zones, alarms, operation modes, voice commands, hotkeys, the desktop, a default ring tone, images and ring tones for incoming calls, and other settings.

Backup action options 43 comprise an option 31 for data moving, an option 32 for difference storage, and an option 33 for data encryption. Each of the backup action options 43 corresponds to a backup procedure described in the following. The options can be implemented by input fields, radio buttons, checkboxes, other GUIs, or the combination thereof, and be configured in various ways.

Processor 1 receives a selected backup occasion option 41 (step S204), a selected data type 42 (step S206), and a selected backup action option 43 (step S208) from input device 6. Processor 1 determines if mobile phone 100 satisfies the situation corresponding to the selected occasion option 41 (step S210).

When mobile phone 100 satisfies the situation corresponding to the selected back occasion option 41, processor 1 automatically backs up a portion of data 40 corresponding to the selected data type 42 from mobile phone 100 to portable storage device 101 according to the selected backup action option 43 (step S212).

For example, when option 11 is selected, processor 1 generates a backup according to the data backup period indicated by option 11. When option 12 is selected, processor 1 generates a backup of data 40 to portable storage device 101 when mobile phone 100 receives or transmits a message. When option 13 is selected, processor 1 automatically boots mobile phone 100 to generate a backup of data 40 to portable storage device 101 when mobile phone 100 has been shutdown for a predetermined period indicated by option 13, and automatically shuts down mobile phone 100 when the backup operation is finished. When option 14 is selected, processor 1 automatically generates a backup of data 40 to portable storage device 101 after mobile phone 100 boots or before mobile phone shuts down.

When option 31 for moving data is selected, processor 1 deletes the original data 40 in mobile phone 100 after generating a backup thereof.

When option 32 for difference storage is selected, processor 1 determines the difference between data 40 in mobile phone 100 and data in portable storage device 101 before generating a backup, and stores the difference to the portable storage device 101

When option 33 for data encryption is selected, processor 1 displays a keyword input field on display 5 before generating a backup, and verifies a keyword received by the keyword input field. When the keyword is verified, processor 1 generates a backup by encrypting the data copied from mobile phone 100 to portable storage device 101. The data backed up in portable storage device 101 conforms to a common format, such as the vCard format, comprises data field and field tags. Processor 1 only encrypts the data field in the format.

Processor 1 may generate different backup versions with respect to the time the respective versions are generated, and provide the various versions during data restoration.

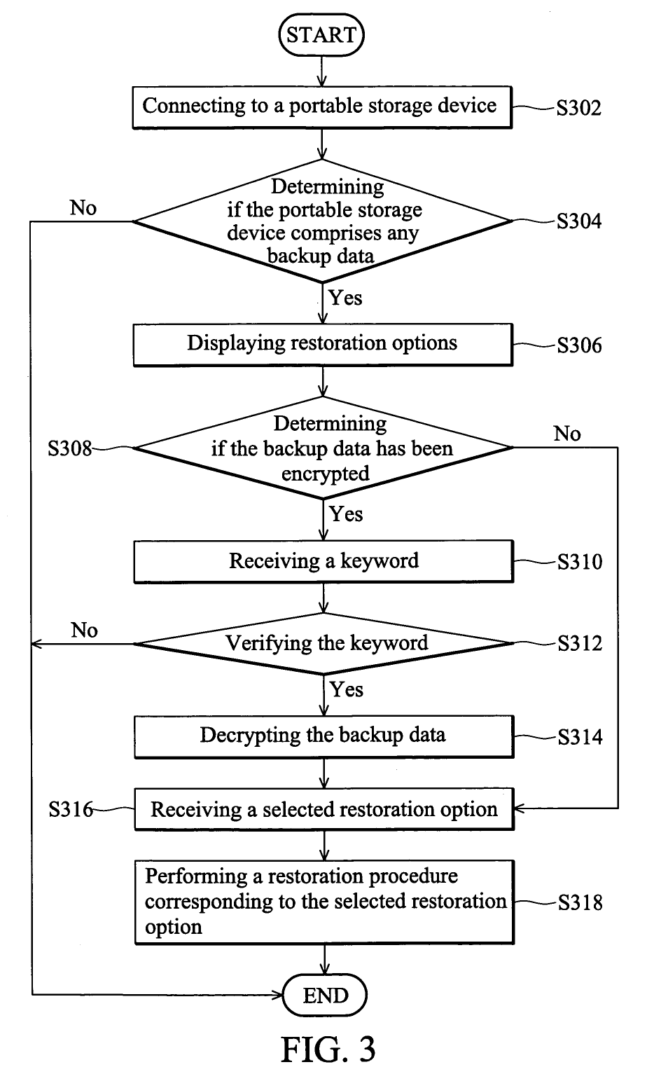

With reference to FIG. 3, mobile phone 100 implements a data restoration method.

When portable storage device 101 connects to interface 3 (step S302), processor 1 automatically determines if portable storage device 101 comprises a backup of data of mobile phone 100 (step S304).

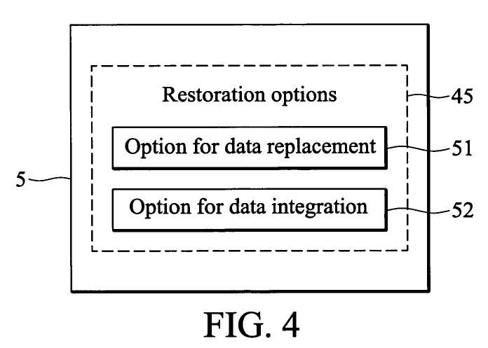

If so, processor 1 automatically displays restoration options 45 on display 5 (step S306). With reference to FIG. 4, restoration options 45 comprises option 51 for data replacement and option 52 for data integration.

Processor 1 determines if backup 102 in portable storage device 101 has been encrypted (step S308). If not, processor 1 directly executes step S316. If so, processor 1 receives and verifies a keyword before responding to any selected restoration option (steps S310 and S312). When the keyword is verified, processor 1 decrypts backup 102 (step S314). Backup 102 may comprise different backup versions displayable on display 5, and processor 1 may even provide functions of previewing these versions.

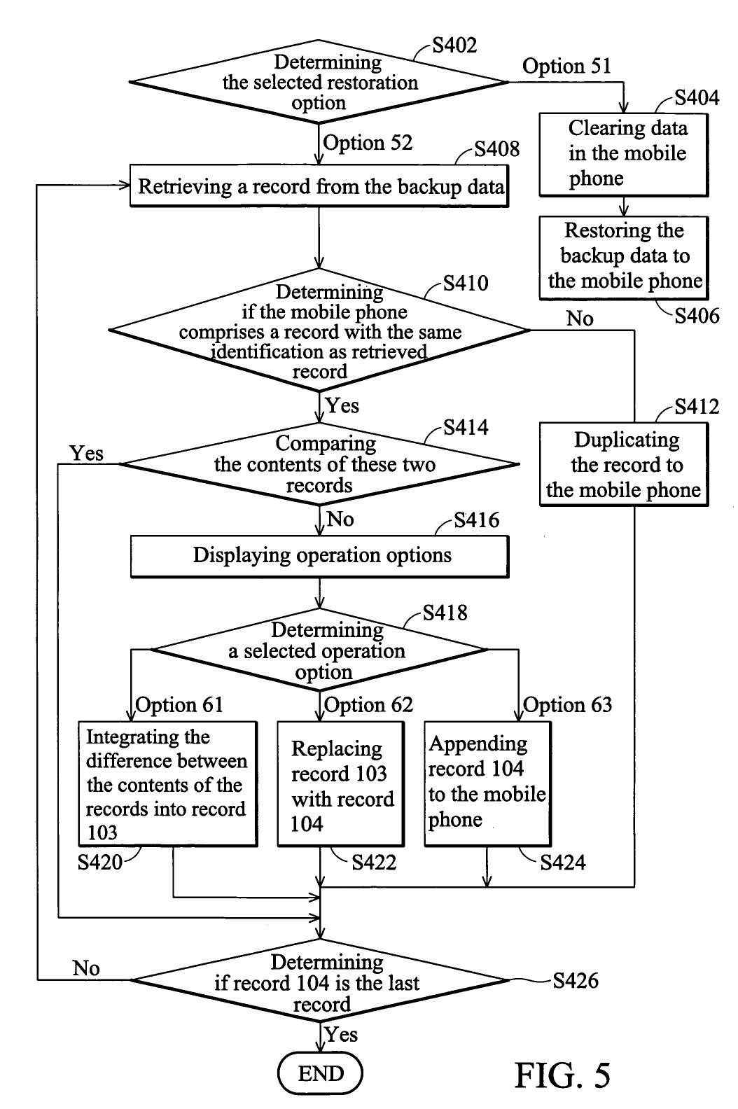

Processor 1 receives a selected restoration option (step S316) and performs a restoration procedure corresponding thereto (step S318). Step S318 is described with reference to FIG. 5.

Processor 1 determines the selected restoration option (step S402). When option 51 for data replacement is selected, processor 1 clears data in mobile phone 100 (step S404) and restores backup 102 data to mobile phone 100 (step S406).

When option 52 for data integration is selected, processor 1 determines the difference between the data in mobile phone 100 and the data in portable storage device 101. For example, processor 1 executes the following steps for each record in backup 102.

Processor 1 retrieves a record 104 from portable storage device 101 (step S408) and determines if mobile phone 100 comprises a record with the same identification as record 104 (step S410). The identification of a record may comprise a username. If not, i.e. when mobile phone 100 lacks record 104, processor 1 duplicates record 104 to mobile phone 100 (step S412) and directly performs step S 426. In step S426, processor 1 determines if record 104 is the last record (step S426). If so, data restoration is completed. If not, processor 1 retrieves a next record and repeats step S408.

When mobile phone 100 comprises record 103 with the same identification as record 104, processor 1 compares the contents of record 103 and record 104 (step S414).

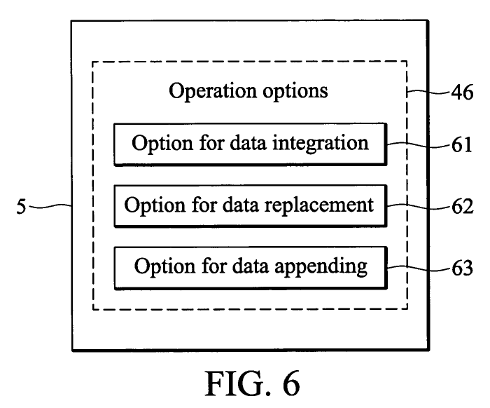

When record 103 and record 104 comprise identical content, processor 1 directly performs step S426. When record 103 and record 104 comprise respectively different contents, processor 1 displays operation options 46 on display 5, as shown in FIG. 6 (step S416).

Processor 1 determines a selected operation option 46 (step S418). When option 61 for data integration is selected from operation options 46, processor 1 integrates the difference between the content of record 103 and the content of record 104 into record 103 (step S420).

When option 62 for data replacement is selected from operation options 46, processor 1 replaces record 103 by record 104 (step S422).

When option 63 for data appending is selected from operation options 46, processor 1 appends record 104 to mobile phone 100 (step S424). The original identification of records 103 and 104 may remain or partly changes by one record. Step S426 is then performed.

Thus, a mobile communication device connected with a portable storage device can automatically back up data according to predetermined backup time and backup rules and scan for backup data to provide backup options during data restoration.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data backup method, implemented in a mobile phone, comprising:
displaying backup occasion options respectively corresponding to different situations of the mobile phone;
retrieving a selected option corresponding to a situation from backup occasion options;
when the mobile phone satisfies the situation corresponding to the selected option, automatically generating a backup by copying data from the mobile phone to a portable storage device connected thereto.

2. The method as claimed in claim 1, wherein the selected option indicates period for backing up the data, and the mobile phone generates the backup according to the period.

3. The method as claimed in claim 1, wherein, according to the selected option, the mobile phone generates the backup when receiving or transmitting a message.

4. The method as claimed in claim 1, wherein, according to the selected option, the mobile phone automatically boots to generate the backup when having been shutdown for a predetermined period, and is automatically shut down after generating the backup.

5. The method as claimed in claim 1, wherein, according to the selected option, the mobile phone automatically generates the backup after booting or before shutdown.

6. The method as claimed in claim 1, further comprising:
displaying backup action options, each corresponding to a backup procedure;
receiving a selected backup action from the backup action options; and
generating the backup according to a backup procedure corresponding to the selected backup action.

7. The method as claimed in claim 6, wherein the selected action comprises a data moving operation, and the mobile phone deletes the data therein after generating the backup.

8. The method as claimed in claim 6, wherein the selected action comprises a difference storage operation, and the mobile phone determines the difference between the data therein and data in the portable storage device before generating the backup and stores the difference to the portable storage device.

9. The method as claimed in claim 6, wherein the selected backup action comprises an encryption action, further comprising:
displaying a keyword input field before generating the backup;
verifying a keyword received by the keyword input field; and
when the keyword is verified, generating the backup by encrypting the data copied from the mobile phone to the portable storage device.

10. The method as claimed in claim 9, wherein the data copied to the portable storage device conforms to a common format comprising data field and field tags, and only the data field is encrypted in the encrypting.

11. The method as claimed in claim 1, further comprising:
displaying data types dedicated to be processed by different applications in the mobile phones;
receiving a selected data types from the data types; and
generating the backup according to the selected data types.

12. The method as claimed in claim 11, wherein the data types comprise a phone book, communication logs, messages, system settings, notes, and schedules.

13. A data restoration method, implemented in a mobile phone, comprising:
upon a connection to a portable storage device, automatically determining if the portable storage device comprises backup data of the mobile phone;
if so, automatically displaying restoration options comprising a replace action;
when the replace action is selected, clearing data in the mobile phone; and
restoring the backup data to the mobile phone.

14. The method as claimed in claim 13, wherein the restoration options comprise a data integration action, further comprising:
when the data integration action is selected, determining the difference between data in the mobile phone and data in the portable storage device; and
when the mobile phone lacks a record stored in the portable storage device, copying the record to the mobile phone.

15. The method as claimed in claim 14, further comprising, when a first record in the mobile phone comprises has the same identification as a second record in the portable storage device, comparing the content of the first record and the second record.

16. The method as claimed in claim 15, further comprising:
when the first record and the second record have different contents, displaying operation options; and
when an integration operation is selected from the operation options, integrating the difference of the content of the first record and the content of the second record into the first record.

17. The method as claimed in claim 15, further comprising:
when the first record and the second record have different contents, displaying operation options; and
when a replace operation is selected from the operation options, replacing the first record with the second record.

18. The method as claimed in claim 15, further comprising:
when the first record and the second record have different contents, displaying operation options; and
when an appending operation is selected from the operation options, appending the second record to the mobile phone.

19. The method as claimed in claim 13, further comprising:
receiving a keyword before responding to any selected restoration option;
verifying the keyword; and
performing the clearing and the restoring when the keyword is verified.

20. The method as claimed in claim 19, further comprising decrypting the backup data before restoring the backup data.
